(19) United States
(12) Patent Application Publication
(10) Pub. No.: US 2012/0187093 A1
(43) Pub. Date: Jul. 26, 2012

(54) FILLER MATERIAL FOR WELDING

(76) Inventors: Mohamed Youssef Nazmy, Fislisbach (CH); Claus Paul Gerdes, Ruetihof (CH); Andreas Kuenzler, Baden (CH); Sorin Keller, Oberrohrdorf (CH)

(21) Appl. No.: 13/346,830

(22) Filed: Jan. 10, 2012

(30) Foreign Application Priority Data
Jan. 20, 2011 (CH) 00099/11

(51) Int. Cl. B23K 9/18; C22C 38/18; C22C 38/32; C22C 38/54; C22C 38/24; C22C 38/00; C22C 38/44; C22C 38/46; B23K 33/00; C22C 38/22

(52) U.S. Cl. 219/73; 219/137 R; 420/42; 420/64; 420/69; 420/35; 420/82; 420/87; 420/106; 420/109

(57) ABSTRACT

A filler material for welding is characterized by the following chemical composition (amounts in % by weight):
0.05-0.15 C,
8-11 Cr,
2.8-6 Ni,
0.5-1.9 Mo,
0.5-1.5 Mn,
0.15-0.5 Si,
0.2-0.4 V,
0-0.04 B,
1-3 Re,
0.001-0.07 Ta,
0.01-0.06 N,
0-60 ppm Pd,
max. 0.25 P,
max. 0.02 S,
remainder Fe and manufacturing-related unavoidable impurities. The material has outstanding properties, in particular a good creep rupture strength/creep resistance, a good oxidation resistance and a very high toughness.

This application claims priority under 35 U.S.C. §119 to Swiss Application No. 00099/11, filed 20 Jan. 2011, the entirety of which is incorporated by reference herein.

### BACKGROUND

1. Field of Endeavor

The invention deals with the field of materials science. It relates to a steel-based filler material for welding which is distinguished by improved meltability during welding and by a higher creep rupture strength after solidification compared to known filler materials for welding.

2. Brief Description of the Related Art

It is known to produce rotors of thermal turbomachines, for example gas turbines, from individual disks which are then welded to each other. By way of example, this has been carried out by ABB and ALSTOM for decades using an arc fusion welding process/submerged arc welding process.

The efficiency of gas turbines is increased, inter alia, by operating them at extremely high temperatures. Therefore, the rotors have to have both a high creep rupture strength at very high temperatures and also good further mechanical properties and a good oxidation resistance. It is self-evident that this also applies to the weld seams via which the rotor disks are connected to each other.

The use of a filler material for welding having the following chemical composition (amounts in % by weight) is known from the prior art for the submerged arc welding of such gas turbine rotors:

0.09-0.14 C, max. 0.40 S, max. 1.40 Mn, max. 0.025 P, max. 0.020 S, max. 11.00-12.50 Cr, 2.00-2.60 Ni, 0.95-1.80 Mo, 0.20-0.35 V, 0.020-0.055 N, remainder iron.

This filler material for welding is known by the name SZW 3001-UP. It is supplied as a wire, where the tensile strength of the weld deposit is in the range from 700 to 1200 N/mm² and the permissible deviation of the strength within a batch may not be more than +/−50 N/mm². According to delivery conditions, this filler material for welding is used for submerged arc joining welds and build-up welds.

However, this material no longer always satisfies the high demands of modern gas turbines, in particular with regard to high-temperature properties such as, for example, the creep rupture strength.

EP 2 221 393 A1 discloses a filler material for welding which has improved properties, can be used for welding gas turbine rotors and has the following chemical composition (amounts in % by weight): 0.05-0.14 C, 8-13 Cr, 1-2.6 Ni, 0.5-1.9 Mo, 0.5-1.5 Mn, 0.15-0.5 Si, 0.2-0.4 V, 0-0.04 B, 2.1-4.0 Re, 0-0.07 Ta, O-max. 60 ppm Pd, remainder Fe and manufacturing-related unavoidable impurities.

A further improvement in the properties of this filler material for welding which is known from EP 2 221 393 A1, in particular with regard to the toughness properties, is desirable.

### SUMMARY

One of numerous aspects of the present invention includes a steel-based, high-temperature-resistant filler material for welding which, in addition to good meltability during welding and a high creep rupture strength after solidification, also has good toughness properties and a good oxidation resistance compared to known filler materials for welding.

Another aspect includes a filler material for welding which has the following chemical composition (amounts in % by weight):
0.05-0.15 C,
8-11 Cr,
2.8-6 Ni,
0.5-1.9 Mo,
0.5-1.5 Mn,
0.15-0.5 Si,
0.2-0.4 V,
0-0.04 B,
1-3 Re,
0.001-0.07 Ta,
0.01-0.06 N,
0-60 ppm Pd,
max. 0.25 P,
max. 0.02 S,
remainder Fe and manufacturing-related unavoidable impurities.

Compared to the materials which are known from the prior art and used as filler material for welding, a material embodying principles of the present invention can be distinguished by a greatly improved creep rupture behavior and a greatly improved notched impact strength. Given a small improvement in the values for elongation at rupture, only small losses of yield strength and tensile strength have been determined in a tensile test at room temperature.

This can be attributed to the combination of the alloying constituents in the indicated ranges.

Specifically, the following should be stated in this respect:

Cr is a carbide-forming element which, in the indicated range of 8-11% by weight, preferably 10% by weight, increases the oxidation resistance; higher values lead to undesirable depositions which disadvantageously cause the material to become brittle.

Re is an element which, in the indicated amounts of 1 to 3, preferably of 2.25% by weight, very readily contributes to the strengthening of the solid solution and thereby leads to good strength values, in particular also to good creep rupture strength values.

B is an element which, in the indicated amounts of up to max. 0.04, preferably 0.01% by weight, strengthens the grain boundaries. It additionally also stabilizes the carbides. Higher boron contents are critical since these may lead to undesirable depositions of boron which have an embrittling effect. The interaction between boron and the other constituents, in particular Ta (in the range of 0.001-0.07% by weight), results in good strength values, in particular during creeping.

Ta acts as an element for strengthening depositions and increases the high-temperature resistance. By contrast, if more than 0.07% by weight Ta is used, the oxidation resistance will disadvantageously be reduced.

Si is an element which, in the indicated range of 0.01-0.5% by weight, preferably 0.3% by weight, ensures that the filler material for welding has an improved meltability. When a filler material for welding as described herein is used, the weld deposit therefore becomes more fluid and it is easier to carry out the welding. In addition, the oxidation resistance is increased; however, the addition of Si disadvantageously promotes the formation of undesirable, embrittling phases in the material.

Mn is an austenite-stabilizing element. In the indicated range of 0.5-1.5% by weight, preferably 1% by weight, it increases the toughness of the material.

Ni is likewise an austenite-stabilizing element. The Ni contents of 2.8-6% by weight, preferably 4% by weight, which are higher compared to the materials known from the prior art, lead to a major increase in the toughness of the filler material for welding, without the creep rupture strength and the strength at room temperature being significantly reduced. Ni contents above 6% by weight have a negative effect on the creep rupture behavior, however, and therefore this value must not be exceeded.

Mo and V are carbide-forming elements and, when added in the claimed ranges (0.5-1.9% by weight Mo, preferably 1.7% by weight Mo, and 0.2-0.4% by weight V, preferably 0.35% by weight V), have a positive effect on the oxidation resistance.

Even very small amounts of Pd (max. 60 ppm, preferably 10 ppm) can contribute to an increase in the strength, because Pd is an element for strengthening the solid solution and also improves the oxidation resistance.

The addition of 0.01-0.06% by weight, preferably 0.04% by weight, N forms VN, which is very stable and has a positive effect on the creep behavior, i.e., the creep rupture strength properties of the material. In conjunction with the increased Ni contents of the filler material for welding as described herein, this produces a better combination of high toughness paired with a very good creep rupture behavior compared to the material known from the prior art.

### BRIEF DESCRIPTION OF THE DRAWINGS

The drawing shows exemplary embodiments of the invention. In the drawing:

FIG. 1 shows the yield strength and tensile strength as bar charts for some of the alloys investigated;

FIG. 2 shows the elongation at rupture as bar charts for the same alloys investigated as in FIG. 1;

FIG. 3 shows the rupture time at 600° C./160 MPa as a bar chart for some of the alloys investigated, and

FIG. 4 shows results of notched-bar impact bending tests at room temperature.

### DETAILED DESCRIPTION OF EXEMPLARY EMBODIMENTS

In the text which follows, the invention will be explained in more detail with reference to exemplary embodiments and the drawings.

The commercial alloy SZW 3001, known from the prior art, and the alloy SZWX3 according to EP 2 221 393 A1 were used as the comparative alloys, and the materials SZWX5-7 as described herein were used. The chemical compositions (amounts in % by weight) are indicated in table 1 below:

TABLE 1
Chemical composition of the investigated alloys

| | SZW3001 | SZWX3 | SZWX5-7 |
|---|---|---|---|
| Fe | Remainder | Remainder | Remainder |
| Cr | 12 | 12 | 10 |
| Ni | 2.3 | 2.3 | 4 |
| Mn | 1 | 1 | 1 |
| Si | 0.4 | 0.4 | 0.27 |
| C | 0.12 | 0.12 | 0.12 |
| Mo | 1.7 | 1.7 | 1.7 |
| V | 0.35 | 0.35 | 0.35 |
| B | — | — | 0.01 |
| Re | — | 3 | 2.25 |
| Ta | — | 0.01 | 0.001 |
| N | 0.002 | 0.002 | 0.04 |
| P | <0.025 | <0.025 | <0.025 |
| S | <0.02 | <0.02 | <0.02 |
| Pd | 0 | 0.005 | 0.001 |

The alloys embodying principles of the present invention were produced as follows:

They were melted several times in an arc furnace as blocks having a diameter of about 50 mm. They were subsequently subjected to stress-relief annealing (610° C./6 h/furnace cooling). Then, conventional tensile and creep samples were produced therefrom, as were ultrasmall samples measuring 3 mm×4 mm×27 mm for notched-bar impact bending tests with a V-notch and a notch depth of 1 mm, a notch radius of 0.1 mm and an opening angle of the notch of 60°.

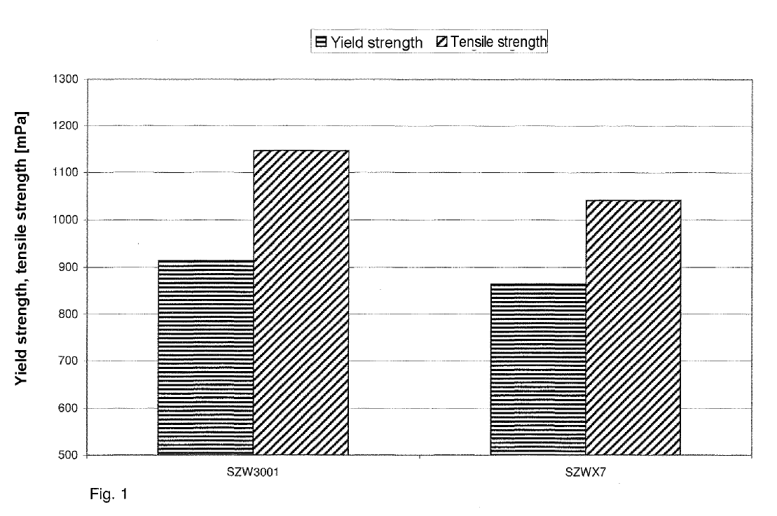

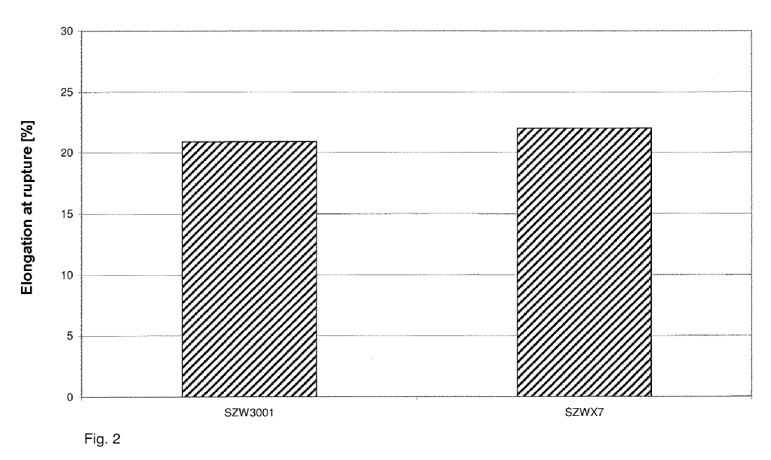

FIG. 1 and FIG. 2 show the results of the tensile tests at room temperature for the weld deposit for the comparative material SZW3001 and the filler material for welding SZWX7.

FIG. 1 shows the yield strength (horizontal hatching) and the tensile strength (diagonal hatching) each as bar charts. Although the alloy SZWX7 has a small drop in strength compared to the previously used filler material for welding SZW3001 and the filler material for welding SZWX3 known from EP 2 221 393 A1 (not shown in FIGS. 1 and 2), i.e., the yield strength has dropped from 914 to 865 MPa and the tensile strength has dropped from 1147 or 1143 MPa to 1041 MPa, conversely the elongation at rupture thereof has increased as expected to 22%, compared to 20.9 or 18.5% (see FIG. 2).

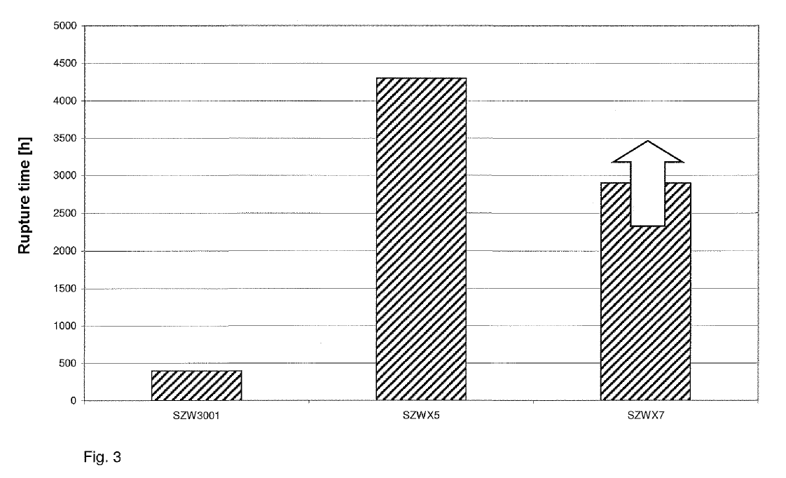

FIG. 3 shows the creep rupture behavior of the weld deposit. This shows the rupture time at 600° C. under a loading of 160 MPa as a bar chart for the materials investigated. The investigated samples according to principles of the present invention advantageously have significantly better creep rupture strength properties than the SZW3001 and SZWX3 known from the prior art (the latter is not shown in FIG. 3). The clearest reflection of this advantage can be seen in the case of the sample SZWX5. Under the conditions mentioned above, it resisted for more than about 11 times longer (4300 h) than the comparative samples made of SZW3001 (396 h) and about 5 times longer than the comparative sample produced from SZWX3 (838 h). It can be deduced that the SZWX7 sample has a similar behavior, because it still did not rupture after 3400 hours of loading under the conditions mentioned above, as indicated by the arrow in FIG. 3.

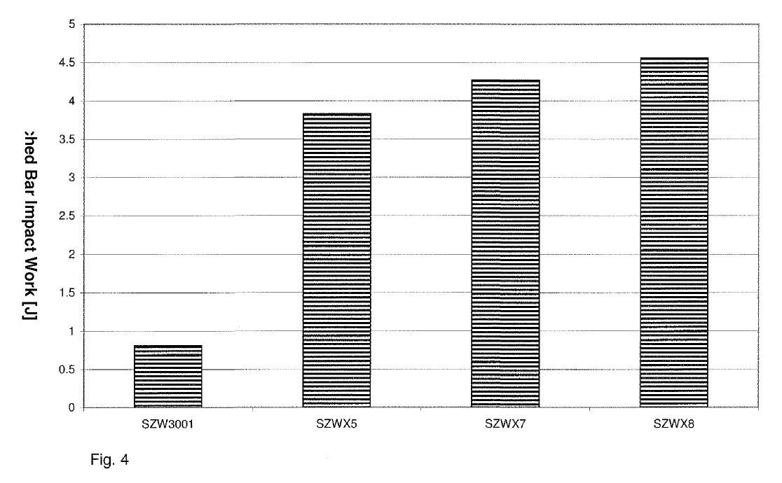

Finally, FIG. 4 shows the notched-bar impact work for the weld deposit as determined on ultrasmall samples at room temperature for various materials. A notched-bar impact work which is about five times higher than that of the comparative sample SZW3001 was determined for the samples produced from the filler material for welding as described herein.

This very good combination of the properties (outstanding toughness properties combined with a very good creep rupture behavior and only minor losses in strength) is achieved by the indicated combinations of the various alloying elements.

This can largely be attributed to the fact that this alloy, in addition to the constituents of the filler material for welding SZW3001 known from the prior art, additionally also contains 1-3% by weight, in particular 2.25% by weight, Re and 0.01% by weight B. Here, the rhenium acts as a very effective element for strengthening the solid solution, while boron stabilizes the carbides and reduces the coarsening thereof. Both mechanisms improve the creep rupture strength of the weld deposit. In addition, the creep rupture strength is increased by the formation of VN, which is formed by the addition of N in the range of 0.01 to 0.06, preferably 0.04% by weight. The increase in the Ni content, preferably to 4% by weight, greatly improves the toughness properties, in particular the notched impact strength. However, the nickel content should not exceed 6% by weight, because otherwise the microstructure is not optimal on account of austenite formation and therefore the creep rupture strength is disadvantageously reduced.

The investigated material according to principles of the present invention is distinguished by a very good meltability, and therefore when the material is used as the filler material for welding, the weld deposit becomes more fluid and it is easier to carry out the welding. In addition, the oxidation resistance is advantageously increased, and therefore the material can be used with preference for welding gas turbine rotors.

It goes without saying that the invention is not restricted to the exemplary embodiments described.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A filler material for welding having the following chemical composition (amounts in % by weight):
0.05-0.15 C,
8-11 Cr,
2.8-6 Ni,
0.5-1.9 Mo,
0.5-1.5 Mn,
0.15-0.5 Si,
0.2-0.4 V,
0-0.04 B,
1-3 Re,
0.001-0.07 Ta,
0.01-0.06 N,
0-60 ppm Pd,
max. 0.25 P,
max. 0.02 S,
remainder Fe and manufacturing-related unavoidable impurities.

2. The filler material for welding as claimed in claim 1, wherein the C content is 0.10-0.14% by weight.

3. The filler material for welding as claimed in claim 1, wherein the C content is 0.12% by weight.

4. The filler material for welding as claimed in claim 1, wherein the Cr content is 10% by weight.

5. The filler material for welding as claimed in claim 1, wherein the Ni content is 3-4% by weight.

6. The filler material for welding as claimed in claim 1, wherein the Mn content is 1% by weight.

7. The filler material for welding as claimed in claim 1, wherein the Si content is 0.2-0.3% by weight.

8. The filler material for welding as claimed in claim 1, wherein the Mo content is 1.7% by weight.

9. The filler material for welding as claimed in claim 1, wherein the Re content is 2.25% by weight.

10. The filler material for welding as claimed in claim 1, wherein the B content is 0.005-0.2% by weight.

11. The filler material for welding as claimed in claim 1, wherein the B content is 0.01% by weight.

12. The filler material for welding as claimed in claim 1, wherein the Pd content is 10 ppm.

13. The filler material for welding as claimed in claim 1, wherein the V content is 0.35% by weight.

14. The filler material for welding as claimed in claim 1, wherein the Ta content is 0.001% by weight.

15. The filler material for welding as claimed in claim 1, wherein the N content is 0.02-0.05% by weight.

16. The filler material for welding as claimed in claim 1, wherein the N content is 0.04% by weight.

17. A method of making a portion of a rotor, the method comprising:
providing a filler material for welding according to claim 1; and
welding together two rotor disks with said filler material.

18. The method according to claim 17, wherein welding comprises arc fusion welding.

19. The method according to claim 17, wherein welding comprises submerged arc welding.
